(19) United States
(12) Patent Application Publication
(10) Pub. No.: US 2009/0238747 A1
(43) Pub. Date: Sep. 24, 2009

(54) PRODUCTION OF OXIDIC NANOPARTICLES

(76) Inventors: Matthias Koch, Wiesbaden (DE); Ralf Anselmann, Luedinghausen-Seppenrade (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/721,265

(22) PCT Filed: Nov. 11, 2005
(86) PCT No.: PCT/EP2005/012105

§ 371 Date: Jun. 8, 2007

(30) Foreign Application Priority Data
Dec. 9, 2004 (DE) 10 2004 059 210.1

(51) Int. Cl. C01G 25/02; C01B 33/12; C01F 11/46; C01G 23/053; C01G 9/02

(52) U.S. Cl. 423/335; 423/554; 423/610; 423/608; 423/622; 423/612; 423/611

(57) ABSTRACT

The invention relates to a method for producing (semi)metal oxides and hydroxides, such as Si02, Ti02, Zr02, Zn0 and other (semi)metal salts such as BaSO4, which can be produced by emulsion precipitation in the form of nanoparticles from an aqueous solution. The invention also relates to the use of the same.

The present invention relates to a process for the preparation of (semi)metal oxides and hydroxides, such as SiO₂, TiO₂, ZrO2, ZnO, and other (semi)metal salts, such as BaSO₄, which can be prepared by emulsion precipitation from aqueous solution in the form of nanoparticles, and to the use thereof.

Nanoscale materials, due to their large surface area/volume ratio, have advantageous properties for various industrial applications, making them more suitable for various applications than micro- or macroscopic particles of the same chemical composition. Advantageous applications for these materials are found in virtually all branches of industry.

The properties of nanomaterials are particularly advantageous for use as fillers or for catalytic processes. For example, nanotechnical improvements to already-available catalysts give access to supported catalysts having novel properties or enable precise control of the catalyst properties.

The use of suitable nanomaterials enables the performance of batteries, rechargeable minibatteries and electrochemical capacitors to be increased. Many sensors can only be produced through the use of nanoparticles. Many oxides are therefore only suitable for use as sensor material, for example for chemical sensors (for example glucose sensor), in nanocrystalline form. Examples of biosensors are so-called lab-on-a-chip systems.

Further areas of application are found in the area of information processing and transmission in the form of electronic, optical or optoelectronic components.

The introduction of nanoscale oxides into a very wide variety of materials enables essential material properties, such as, for example, hardness, wear resistance, etc., to be improved in a targeted manner. Many structural applications of nanocrystalline particles arise from a specific distribution of nanoparticles in a ceramic, metallic or polymer matrix,

The mechanical properties of metals can be improved, for example, by the introduction of nanoscale particles, which can at the same time make a significant contribution to lightweight construction.

Polymers provided with nanoparticles have features which are between those of organic polymers and inorganic ceramics. Potential uses of materials optimised in this way are found in particularly demanding areas of lightweight construction or in high-temperature applications, but also in mass applications, such as plastic casings or panelling. Emphasis should be placed, for example, on the ductile behaviour of nanostructured ceramics, which were hitherto known exclusively as brittle materials. In practice, this gives rise to a multiplicity of innovations in ceramic technology.

Significant property improvements are also possible in building materials through the admixture of nanoadditives (for example high-performance concretes having higher compressive strengths at the same time as improved wear and erosion resistance). The use of titanium dioxide nanoparticles as additives in paints enables the resistance to discoloration due to artificial light and daylight to be increased.

Another important area of application of nanoscale materials is found in cosmetics. Titanium oxide or zinc oxide particles on a nanoscale are employed, for example, in sunscreens. As far as is known today, sunscreen products containing nanoparticles exhibit greater effectiveness and are tolerated better by the skin than conventional products.

Owing to the broad range of applications and the significantly better properties compared with oxides prepared in a conventional manner, a very wide variety of processes for the preparation of nanoscale oxides have been developed.

Oxides in the form of nanoparticles cannot usually be produced by grinding macroscopic particles, but instead the process for the production of these materials must be designed specifically for the production of these extremely small particles, since the particles produced must have relative diameters smaller than 100 nm.

Processes developed for this purpose are modifications of processes that are already known for the preparation of powder materials, such as, for example, flame pyrolysis, precipitation from dilute solutions or corresponding electro-chemical processes.

WO 03/014011 A1 describes, for example, a solvopyrolytic process for the preparation of nanoscale, divalent metal oxides which is carried out at relatively low temperature without additional oxygen using a special precursor. For this purpose, compounds of the general formula RMOR′, in which M denotes beryllium, zinc, magnesium or cadmium, and R and R′, independently of one another, denote alkyl groups having 1-5 C atoms, are pyrolysed in a suitable solvent in the presence of an inert atmosphere at a temperature below 300° C., Agglomerate formation is prevented by the addition of a special complexing agent, which is absorbed at the surface of the nanoparticles formed.

GB 2,377,661 A describes a process for the production of nanoparticles in which the particles are formed from a solution on a rotating surface. Particle agglomeration is prevented by adjusting the viscosity of the liquid used and by crystallisation on the surface of the rotating area.

Schur et al. (Angew. Chem. 2003, 115, 3945 3947) describe a process for the preparation of catalysts in which continuous co-precipitation takes place using a microreactor. The process is carried out using a commercial micro-reactor having channels with a length of 100 mm and a width of 200 μm. The reagents, 0.15M metal nitrate solution and 0.18M sodium carbonate solution, are reacted at pH 7.0 with precise temperature control and defined flow conditions with constant throughput at 328 K. The product is collected in a cold settling tank and worked up by washing, drying and subsequent calcination to give Cu/ZnO particles. It is essential for the feasibility in the microreactor that dilute solutions are used, so that blockages cannot form in the channels of the microreactor used.

The processes known to date can thus either only be carried out with difficulty, are expensive, or the particles produced have a very broad size distribution. Another problem consists in that the particles formed tend towards agglomeration. Still other processes cannot readily be carried out continuously or have to be carried out with dilute solutions, so that large amounts of solvent subsequently have to be disposed of or worked up.

The object of the present invention is therefore to provide an inexpensive process for the preparation of nanoscale metal oxides which can be carried out simply to and continuously and, while preventing agglomeration, gives particles having a narrow size distribution, with a high solid yield being achieved at the same time.

The present object is achieved by emulsification of an aqueous solution of a suitable starting material in a water-immiscible solvent with the aid of a special emulsifier or emulsifier mixture in a micromixer. Addition of a suitable reactant to the resultant emulsion results in the formation of the desired particles therein.

In particular, the present object is achieved by a process for the preparation of (semi)metal oxides and hydroxides, such as SiO₂, TiO₂, ZrO₂, ZnO, and other (semi)metal salts, such as BaSO₄, in the form of nanoparticles having a narrow size distribution in the range 1 nm-1 μm, in particular from 10 to 200 nm, in which a) an aqueous solution containing starting material is emulsified by intensive mixing in a microreactor with an emulsifier-containing, organic solution,

b) the resultant emulsion is fed into a reaction solution containing the further reaction partner in a water-immiscible solvent,
c) the reactant present in the reaction solution interacts with the aqueous droplets containing starting material and reacts with the starting material with particle formation, and
d) the nanoparticles formed are isolated by separating off the solvent.

In order to carry out the process according to the invention, use is preferably made of at least one emulsifier from the group

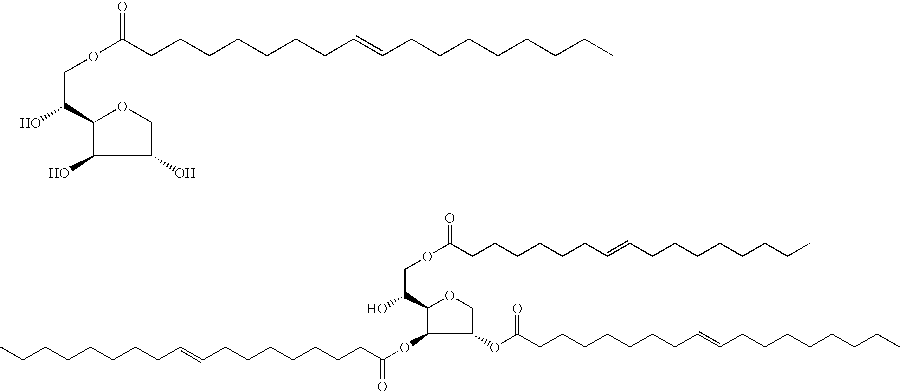

C₁₈H₃₇(OCH₂CH₂)ₙOH where n˜2,
C₁₈H₃₅(OCH₂CH₂)ₙOH where n˜2,
RO(CH₂CH₂O)ₙH where n˜3 and R=C₁₃H₂₇,
RO(CH₂CH₂O)ₙH where n˜3 and R=C₁₃C₁₅-oxo alcohol,
RO(CH₂CH₂O)ₙH where n˜3 and R=C₁₂C₁₄-fatty alcohol.

In accordance with the invention, an aqueous phase and an emulsifier-containing organic solution are mixed with one another in step a) in a volume ratio in the range between 1:20 and 1:1, preferably between 1:10 and 1:2, where the emulsifier is present in the organic solvent or solvent mixture in an amount in the range from 0.5 to 4% by weight.

The organic solvents used for the preparation of the requisite emulsifier-containing organic solution can be aliphatic, cycloaliphatic and aromatic hydro-carbons, heteroaliphatic solvents, heteroaromatic solvents or partially or fully halogenated solvents which form a two-phase system with water.

In particular, a solvent from the group octane, cyclohexane, benzene, xylene and diethyl ether, individually or in the form of a mixture, can be used for this purpose.

The starting material is advantageously present in the aqueous solution in an amount in the range 25-45% of the proportion by weight of its solubility in water at room temperature.

In a particular embodiment of the process according to the invention, at least one water-miscible solvent from the group methyl alcohol, ethyl alcohol, acetone, dimethylformamide, dimethylacetamide and dimethyl sulfoxide which is immiscible with the emulsifier-containing organic solution is added to the aqueous phase.

It has been found through experiments that water-soluble salts of the (semi)-metals Ti, Zn, Zr, Si and Ba, in particular salts from the group of the water-soluble salts TiCl₄, TiOCl₂, Zn(OAc)₂, ZrOCl₂ and BaSO₄, can be used for the preparation of nanoscale metal oxides by the improved process.

The present invention also relates to the use of the resultant oxidic nanoparticles according to claims 11 to 13 as X-ray or UV absorbers or UV filters having novel and improved properties.

After the emulsion has been formed, it can be mixed with an organic solution in which the reactant is present in a stoichiometric ratio, or the aqueous emulsion comprising starting material can be fed into an organic solution in which the reactant is present in excess.

The reactants used are acids or bases which result in the formation of the corresponding products. For the preparation of TiO₂ from TiOCl₂ or TiO(SO₄), use can be made, for example, of pyridine or methoxyethylamine, while for the preparation of SiO₂ from sodium water-glass, an organic acid from the group acetic acid, propionic acid and butyric acid is suitable. Neither the list of bases nor of acids should be regarded as exhaustive here. The choice of the corresponding reaction partner is made here on the basis of the knowledge of the person skilled in the art, who makes the choice on the basis of corresponding precipitation reactions known to him.

The preparation of emulsions with the aid of so-called microemulsions is known from the literature. In this case, the emulsion forms spontaneously and under thermodynamic control. A feature of this process is the relatively low concentration by weight of product, i.e. less than 1%, and the large amount of emulsifier, which can be a multiple of the product content.

Surprisingly, it has been found that emulsions of this type are sufficiently stable, even with significantly lower emulsifier concentrations, in order to be able to produce nanoscale particles therefrom so long as these emulsions are prepared using a suitable mixer. The solid concentrations can at the same time be increased to 10% or more, enabling production on an industrial scale. With regard to industrial production, this makes the preparation economic. The process according to the invention offers the following advantages over known processes in accordance with the prior art:
it can be carried out continuously
the energy input into the system is moderate
particles having different diameters can be produced as required
the particles produced have narrow size distributions
no agglomeration of the particles occurs during the synthesis
relatively high solid yields are achieved

The synthesis is carried out by producing crystalline particles from a stabilised emulsion in one process step. In order to prepare the emulsions used, use is made of suitable emulsifiers which stabilise the starting-material droplets until the oxide has formed through reaction with a suitable precipitation reagent. These emulsifiers at the same time prevent agglomeration of the particles in the emulsion.

The requisite emulsions are advantageously produced in situ in the micro-reactor used and do not have to be prepared in advance in a suitable reactor. For this purpose, an aqueous solution of a starting material for the particle synthesis and a solution of a suitable surfactant or emulsifier in a water-immiscible solvent are passed through the microreactor, in which the various solutions are forced to mix intensively by the reactor geometry. Thus, a solution of the starting material (disperse phase) is emulsified in a suitable non-solvent by means of a suitable surfactant (continuous phase). A suitable precipitant is subsequently added to the resultant emulsion. This effects the formation of the oxide materials from the starting materials.

Suitable as the continuous phase are organic solvents, such as aliphatic, cycloaliphatic and aromatic hydrocarbons as well as heteroaliphatic and -aromatic solvents. It is likewise possible to use partially or fully halogenated solvents. The prerequisite for the suitability of the solvent as continuous phase is that it forms a two-phase system with water. Particularly suitable for this purpose are toluene, petroleum ethers having various boiling ranges and cyclohexane.

Suitable emulsifiers are those which have a low HLB value and are capable of stabilising water-in-oil emulsions. Corresponding emulsifiers which are suitable for this purpose are shown by way of example in the following table:

| Trade name | Supplier | Structural formula or empirical formula |
|---|---|---|
| Span 20 | VWR | 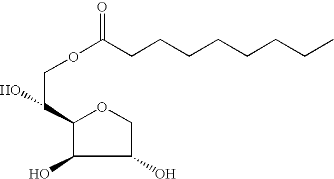 |
| Span 40 | VWR | 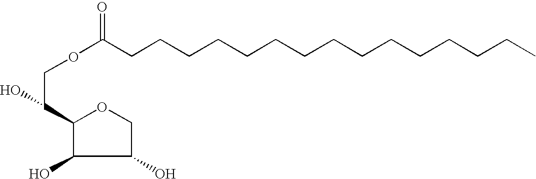 |
| Span 60 | Fluka | 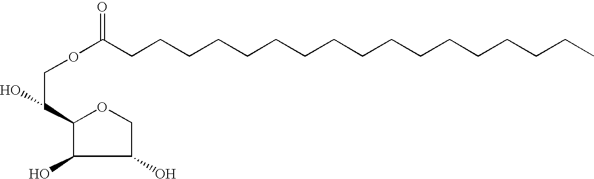 |
| Span 65 | VWR | 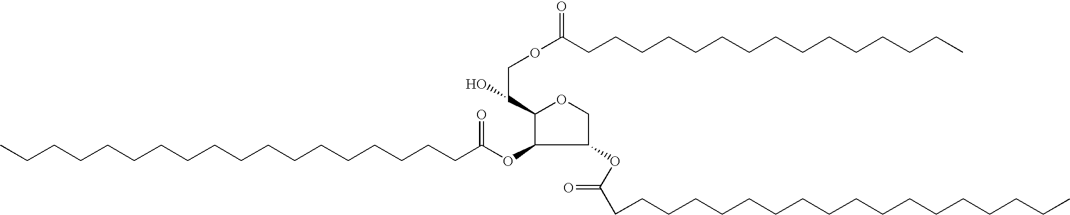 |
| Span 80 | Fluka | 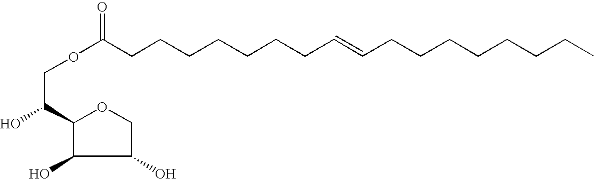 |
| Span 85 | VWR | 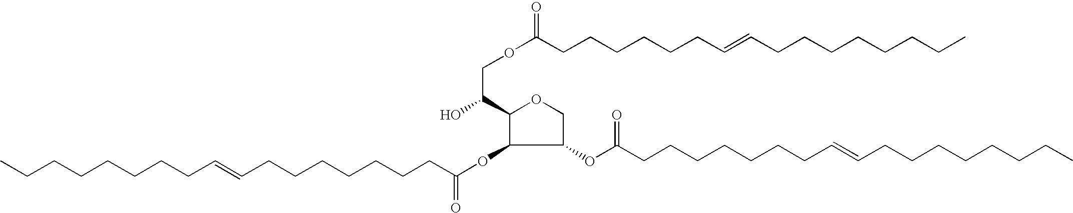 |
| Brij 72 | Fluka | C₁₈H₃₇(OCH₂CH₂)ₙOH n~2 |
| Brij 92V | Fluka | C₁₈H₃₅(OCH₂CH₂)ₙOH n~2 |
| Lutensol TO3 | BASF | RO(CH₂CH₂O)ₙH n~3 R = C₁₃H₂₇ |
| Lutensol AO3 | BASF | RO(CH₂CH₂O)ₙH n~3 R = C₁₃C₁₅-oxo alcohol |
| Lutensol A3N | BASF | RO(CH₂CH₂O)ₙH n~3 R = C₁₂C₁₄-fatty alcohol |

Preferred emulsifiers are sorbitan monooleate, which is commercially avail-able under the name Span 80, and Lutensol TO3 (BASE).

The starting materials employed correspond to those with which the corresponding oxides can be precipitated from aqueous solution.

Ti oxide, Zn oxide and Si oxide or BaSO₄ particles can be produced, for example, by the following chemical reactions in the emulsion drops formed:

TiCl4+2H2O [base]->TiO2+4HCl
TiOCl2+H₂O [base]->TiO2+2HCl

### Zn(OAc)2+2OH—->ZnO+2HOAc+H₂O

ZrOCl2+H₂O [base]->ZrO2+2HCl
Na2SiO3 [acid]->SiO2+2Na+ +H2O

### Ba⁺+SO4⁻->BaSO4

However, the production of corresponding nanoparticles by the process according to the invention is not restricted to these chemical reactions and can also be carried out in another suitable reaction.

The process according to the invention influences the reaction and the particle formation to the effect that it specifies a closed reaction space through the emulsion droplets formed and thus defines the size of the particles forming. The reactions taking place in the droplets correspond to those which would take place during precipitation in a single-phase aqueous system, but with the difference that the reaction here is restricted to the volume of the individual drops

The general procedure begins for all reactions with the preparation of a concentrated aqueous solution of the corresponding starting substance. The proportion by weight of the respective salt is dependent on its solubility and is typically between 25 and 45%. If desired, water-miscible organic solvents, such as methyl alcohol, ethyl alcohol, acetone, dimethylformamide, dimethyl-acetamide or dimethyl sulfoxide, may be present in this aqueous solution. It is essential here that this organic solvent is only miscible with the aqueous phase, but not with the organic phase used for the formation of the emulsion or the continuous phase. In parallel with the aqueous solution, a solution of the emulsifier and any co-emulsifiers in an organic solvent, which is to be used as continuous phase, is prepared. Water-immiscible organic solvents which are suitable for the preparation of the continuous phase are, for example, octane, cyclohexane, benzene, xylene or diethyl ether. Depending on which starting materials are employed, various water-immiscible organic solvents are preferred for the preparation of the emulsion.

An emulsifier solution in which the emulsifier is present in an amount in the range from 0.5 to 4% by weight is usually prepared. The two solutions are mixed intensively and emulsified continuously in the micromixer, where the ratio of aqueous phase to continuous phase is between 1:20 and 1:1, preferably between 1:10 and 1:2. After the aqueous solution of the starting compound has been emulsified, the reaction to give the end product is carried out, either by continuous feed and mixing of a solution of the reactant (base, acid, etc., corresponding to the above table) in the stoichiometric ratio or by feeding the starting-material emulsion into an excess of reactant.

The emulsifier stabilises the resultant particles even after the reaction and prevents agglomeration thereof. The water-soluble by-products of the reactions can subsequently be washed out, with the insoluble nanoparticles remaining behind.

Static micromixers in which the reaction liquids fed in are mixed intensively are suitable for carrying out the process according to the invention. The intensive mixing can take place through the influence of shear forces, as is the case in very thin lines. Particularly suitable, however, are micromixers in which the liquids are forced to mix by the conduction of the flowing current.

This can take place in static mixers having thin lines with constantly changing cross sections or particularly preferably in mixers having mutually crossing lines. The liquids are subjected to high shear forces, for example in micromixers in which the starting-material solutions are brought together in thin lines at an angle of from 30 to 1500 or in a T-piece, in particular micromixers in which the liquid streams are repeatedly separated and combined again in thin channels, i.e. in so-called “split-and-recombine mixers”. However, suitable static micromixers are not only those constructed from mutually connected plates with thin channels and openings in the surfaces facing one another. It is also possible to employ micromixers constructed from a multiplicity of mutually connected thin, perforated and optionally structured metal sheets in such a way that the micromixer body constructed in this way has in its interior a multiplicity of thin lines in which liquids fed in are mixed intensively with one another. In other suitable types of micromixer, mutually crossing liquid streams are in turn generated by special internals so that emulsion formation takes place.

Suitable micromixers are described, in particular, in Patent Applications DE 1 95 11 603 A1, WO 95/30475 A1, WO 01/43857 A1, DE 1 99 27 556 A1 and WO 00/76648 A1 or in A. van den Berg and P. Bergveld (eds.), Micro Total Analysis Systems, 237-243 (1995) Kluwer Academic Publishers, Netherlands. The types of micromixer described in the cited documents, which are to be regarded as part of the disclosure of this application, correspond to the types described above.

Depending on the desired properties of the particles to be produced, a suitable micromixer which corresponds to one of the types described above and can be employed for the preparation of emulsions is selected from the commercially available micromixers. Particular preference is given to the use for this purpose of micromixers of the “split-and-recombine” type.

A thin hold zone in the form of a thin flow channel, which if possible has the same diameter as the thin mixing channels of the micromixer, is optionally connected to the outlet of the mixer used. In this way, the emulsion droplets in which the starting materials reacting to form the desired particles are confined in an immiscible solution can be collected in a controlled manner in a subsequent reaction volume which contains an organic, water-immiscible solvent and the further reaction partner, and reacted directly at a suitable, constant, set temperature. In this way, particles having virtually identical properties and constant size distribution are obtained in a reproducible, controlled manner.

The process according to the invention furthermore has the advantage that it can be carried out continuously. If large amounts of corresponding products have to be produced, as many micromixers as desired can be operated in parallel with one another, to be precise in parallel with one another in a single plant or in separately operated plants.

The desired solid particles are advantageously not formed in the process according to the invention until after leaving the micromixer and the hold zone optionally connected thereto through reaction in the subsequent reaction volume. In this way, a fault-free course of the process can be ensured and any blockages of the micromixer structures and the subsequent hold zone are avoided if pre-filtered starting-material solutions are used.

Through the process according to the invention, the disadvantages of methods known hitherto for the production of nanoparticles, in particular of Ti, Zn, Si oxide or BaSO₄ particles, are therefore avoided, and it has become possible to produce corresponding nanoparticles in a controlled and reproducible manner with a narrow particle-size distribution and constant properties using inexpensive means, so that particles having a particle size in the range 1 nm-1 μm, in particular from 10 to 200 nm, can be made available continuously and reproducibly. Through the choice of the microreactor employed and its mixing potential and the solvents and emulsifiers employed, the particle size here can be increased or reduced. The mixing potential of the mixer is in turn dependent on its internal structure and the internal dimensions of the channels forming the mixer. Suitable micromixers are those as already described above whose channels have a diameter of from 1 μm to 1 mm and into which the emulsion-forming solutions can be introduced by means of suitable devices and, after flowing through the channels with formation of a fine emulsion, can be treated further in a suitable manner. If required, the micromixer used can be a temperature-controllable type. For temperature control, the micromixer can be permanently connected to a thermocouple. Given a suitable design, however, it is also possible for the micromixer to be surrounded reversibly with a temperature-control medium or with a stream of temperature-control medium, to be immersed in a temperature-control bath or to be warmed by infrared radiation. In order to obtain reproducible results, however, reliable, adjustable temperature control is necessary. Various suitable possibilities for temperature control of micromixers are described in the literature. For example, WO 02/43853 A1 discloses a suitable temperature-control device.

Micromixers which can be employed for carrying out the process according to the invention must consist of materials which are inert to the reaction media. Suitable micromixers are made of glass, silicon, metal or an alloy or of suit-able oxides, such as silicon oxide, or of a plastic, such as polyolefin, polyvinyl chloride, polyamide, polyester, fluorescin or Teflon. The hold zone optionally present and all devices with which the reaction solutions and the emulsions come into contact advantageously also consist of corresponding materials.

In order to carry out the process according to the invention, the starting material-containing aqueous solution and the emulsifier-containing organic solution are pumped continuously from the separate storage containers through thin lines connected to the entry channels into the microreactor(s) with the aid of suitable pumps. Suitable pumps are pumps by means of which small amounts of liquid can be conveyed continuously and uniformly, even against a pressure building up. In particular, preference is given to pumps by means of which the small amounts of liquid can be conveyed in a highly pulse-free manner. Such pumps are commercially available in various designs and are, for example, also sold as injection syringe pumps. Depending on the desired reaction, these pumps can be operated with various capacities.

### EXAMPLE

For better understanding and in order to illustrate the invention, examples are given below which are within the scope of protection of the present invention. However, owing to the general validity of the inventive principle described, these are not suitable for reducing the scope of protection of the present application merely to these examples.

### Example 1

### Nanoscale Titanium Oxide Having a Narrow Size Distribution

A solution of titanyl sulfate (15% in dilute sulfuric acid, Aldrich) is prepared in a container. A solution of Span 80 (Fluka) and Lutensol TO3 (BASF) in cyclo-hexane (ratio 1.5:1.5:9 (% by weight)) is prepared in a second container. The two solutions are fed with the aid of gear pumps from the storage containers through a micromixer as described in patent application DE 1 95 11 603 A1. (The micromixer used works on the “split-and-recombine” principle. Corresponding micromixers are currently marketed by the Institut für Mikromechanik Mainz under the name caterpillar mixers). The volume streams are selected so that they are in the ratio 1:5, based on aqueous and organic phases. An emulsion forms from the starting-material solutions. After mixing in the micromixer, the resultant emulsion is fed through a thin line directly into a solution consisting of 60% by weight of cyclohexane and 40% by weight of methoxyethylamine. On feeding into this solution, uniform titanium oxide particles having a specific diameter of about 30-70 nm form. After removal of the solvent from the emulsifier bonded to the surface, the product formed is stabilised and is redispersible in suitable solvents (cyclo-hexane, toluene, petroleum ether).

### Results:

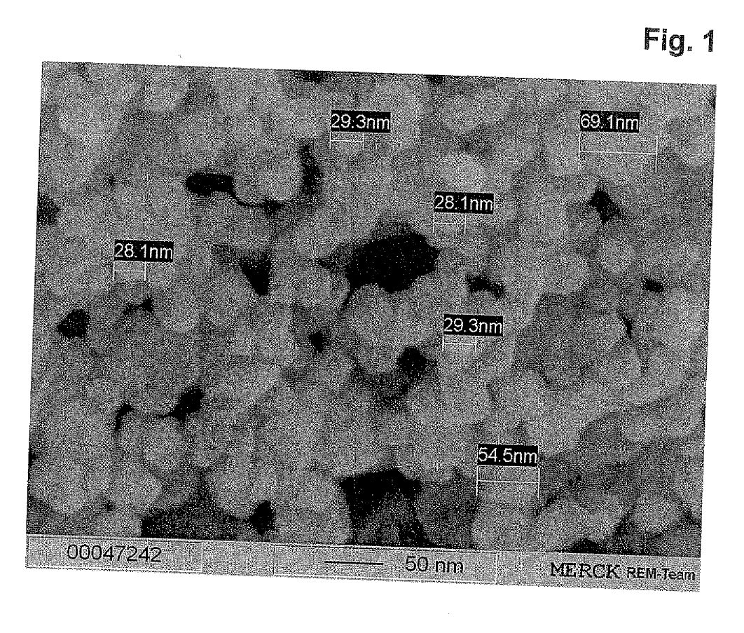

Particles redispersed in toluene were investigated by scanning electron microscopy. A particle size of between 30 and 60 nm was found (FIG. 1).

X-ray diffractometry showed that the particles formed were pure TiO₂ in the anatase modification.

### Example 2

The process is carried out as described in Example 1, with the difference that the continuous phase is now composed of a solution of Span 80 (Fluka) and Lutensol TO3 (BASF) in cyclohexane in the ratio 1.5:1.5:18 (% by weight).

The particles obtained have a diameter of 80-120 nm and are likewise redispersible in organic solvents.

1. Process for the preparation of (semi)metal oxides and hydroxides, such as SiO₂, TiO₂, ZrO₂, ZnO, and other (semi)metal salts, such as BaSO₄, in the form of nanoparticles having a narrow size distribution in the range 1 nm-1 μm, in particular from 10 to 200 nm, characterised in that
a) an aqueous solution containing starting material is emulsified by intensive mixing in a microreactor with an emulsifier-containing, organic solution,
b) the resultant emulsion is fed into a reaction solution containing the further reaction partner in a water-immiscible solvent,
c) the reactant present in the reaction solution interacts with the aqueous droplets containing starting material and reacts with the starting material with particle formation, and
d) the nanoparticles formed are isolated by separating off the solvent.

2. Process according to claim 1, characterised in that use is made of at least one emulsifier from the group 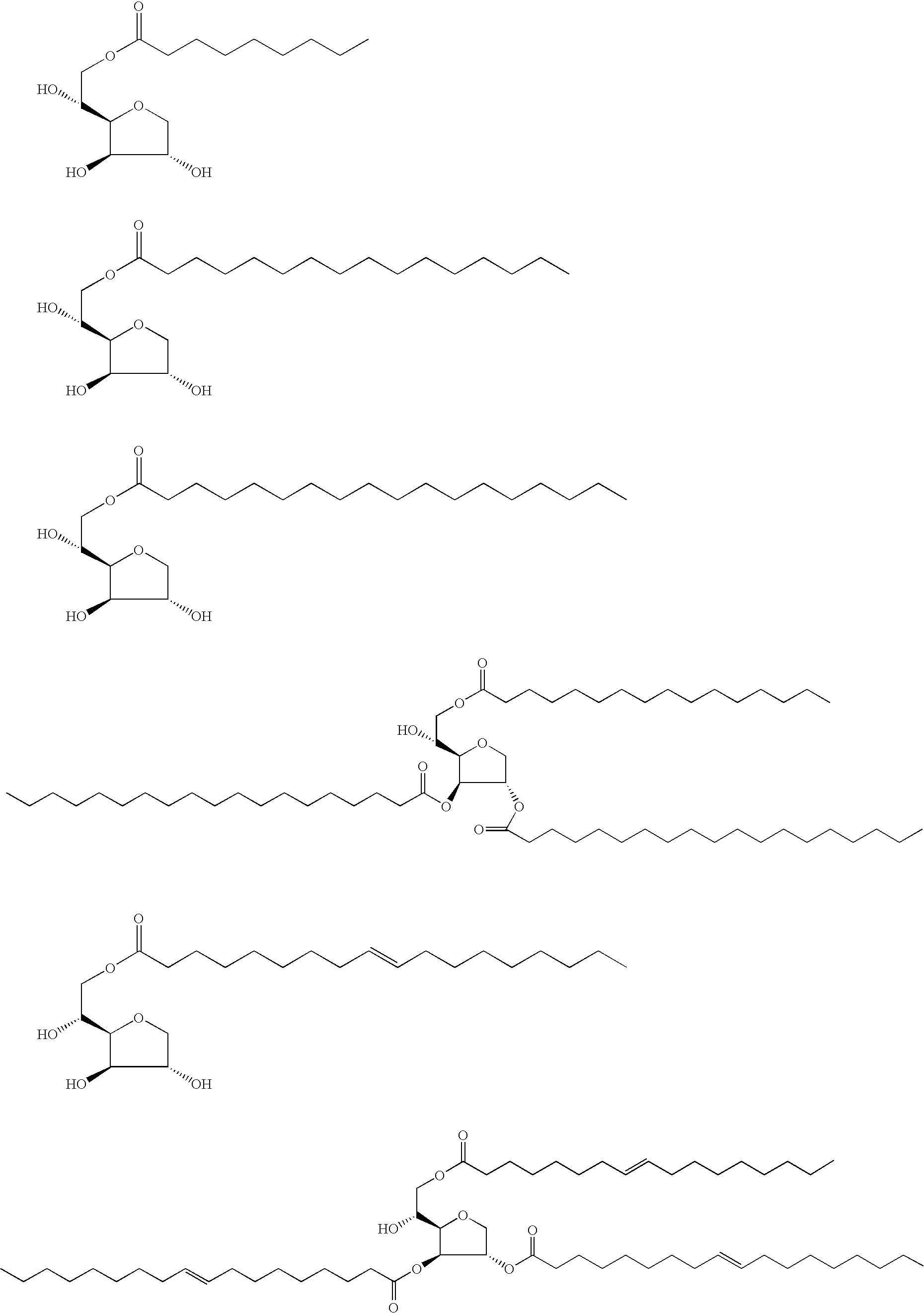
C₁₈H₃₇(OCH₂CH₂)ₙOH where n˜2,
C₁₈H₃₅(OCH₂CH₂)ₙOH where n˜2,
RO(CH₂CH₂O)ₙH where n˜3 and R=C₁₃H₂₇,
RO(CH₂CH₂O)ₙH where n˜3 and R=C₁₃C₁₅-oxo alcohol,
RO(CH₂CH₂O)ₙH where n˜3 and R=C₁₂C₁₄-fatty alcohol.

3. Process according to claim 1, characterised in that an aqueous phase and an emulsifier-containing organic solution are mixed with one another in step a) in a volume ratio of between 1:20 and 1:1, preferably between 1:10 and 1:2, where the emulsifier is present in the organic solvent or solvent mixture in an amount in the range from 0.5 to 4% by weight.

4. Process according to claim 1, characterised in that the organic solvent used for the preparation of the emulsifier-containing organic solution is an aliphatic, cycloaliphatic or aromatic hydrocarbon, heteroaliphatic solvent, heteroaromatic solvent or a partially or fully halogenated solvent which forms a two-phase system with water.

5. Process according to claim 1, characterised in that the organic solvent used for the preparation of the emulsifier-containing organic solution is at least one solvent from the group octane, cyclohexane, benzene, xylene and diethyl ether, individually or in the form of a mixture.

6. Process according to claim 1, characterised in that starting material is present in the aqueous solution in an amount in the range 25-45% of the proportion by weight of its solubility in water at room temperature.

7. Process according to claim 1, characterised in that at least one water-miscible solvent from the group methyl alcohol, ethyl alcohol, acetone, dimethylformamide, dimethylacetamide and dimethyl sulfoxide which is immiscible with the emulsifier-containing organic solution is present in the aqueous phase.

8. Process according to claim 1, characterised in that water-soluble salts of the (semi)metals Ti, Zn, Zr, Si and Ba are used for the preparation of the aqueous phase.

9. Process according to claim 1, characterised in that a salt from the group of the water-soluble salts TiCl₄, TiOCl₂, Zn(OAc)₂, ZrOCl₂ and BaSO₄ is used for the preparation of the aqueous phase.

10. Process according to claim 1, characterised in that, in process step c), the starting material present in the emulsion is mixed with the reactant present in the organic solution in a stoichiometric ratio or the aqueous solution containing starting material is fed into an organic solution in which the reactant is present in excess.

11. Use of the nanoscale ZrO₂ prepared according to claim 1 as X-ray absorber.

12. Use of the ZnO prepared according to claim 1 as UV absorber or filter.

13. Use of the TiO₂ prepared according to claim 1 as UV absorber or filter.

14. A method of absorbing X-ray comprising employing nanoscale ZrO₂ prepared in a process of claim 1 as an X-ray absorber.

15. A method of absorbing or filtering UV radiation comprising employing ZnO or TiO₂ prepared in a process of claim 1 as a UV absorber.
